(19) United States
(12) Patent Application Publication
(10) Pub. No.: US 2004/0236602 A1
(43) Pub. Date: Nov. 25, 2004

(54) Methods for improving the clinical outcome of patient care and for reducing overall health care costs

(76) Inventor: Jeffrey C. Greene, Oklahoma City, OK (US)

Correspondence Address: MCAFEE & TAFT, TENTH FLOOR, TWO LEADERSHIP SQUARE, 211 NORTH ROBINSON, OKLAHOMA CITY, OK, 73102, US

(21) Appl. No.: 10/441,975

(22) Filed: May 20, 2003

(51) Int. Cl. G06F 17/60

(52) U.S. Cl. 705/2

(57) ABSTRACT

The current invention is directed to improved methods for providing health care and for reducing the costs of health care. Additionally, the methods of the current invention are designed to improve the clinical outcome for the patient. The methods of the current invention provide incentives to both the patient and the medical service provider to improve the clinical outcome of the health care treatment and to reduce the overall costs of health care.

### BACKGROUND OF THE INVENTION

Over the last 100 years, health care has evolved from a country doctor visiting patients in a Model T and accepting eggs for payment to an industry dominated by insurance companies, preferred provider organizations (PPO), physician-hospital organizations (PHO), health maintenance organizations (HMO) and other similar associations. Despite the emergence of various health care systems, affordable quality health care delivery is a growing challenge in our modern economy. In many instances, medical providers, mindful of expensive medical malpractice claims and/or as a means to augment their revenue, practice defensive or unnecessary medicine by ordering extra tests and procedures. Similarly, many patients choose not to follow their physician's orders and opt for an unhealthy lifestyle. Both practices significantly increase health care costs.

Some health care systems attempt to control health care costs by managing the practice of medicine. These systems frequently place limits on the number of tests and procedures a practitioner may order for a given medical condition. However due to the personal nature of medical care, Physicians and their patients resent third party interference. Additionally, such interference often adds costs as opposed to lowering costs. Health care delivery that is focused merely on controlling costs does not necessarily improve the well being of the patient. Rather, systems of this type may inadvertently increase health care costs when the illness progresses, ultimately require more aggressive treatment for a condition that could have been resolved more economically with previously denied services. Health care delivery systems that ration or deny care have been the catalyst for the federal government to consider a “patients' bill of rights.” Current HMO and PPO models are simply failing to control the cost of quality health care and are tending to limit access to providers and to more expensive treatments. Equally important, HMOs and PPOs do not meaningfully engage or encourage the patient to self-manage their health. Therefore, a need exists for improved methods of delivering health care. The improved method should enhance the clinical outcome of medical treatment for the patient. Additionally, the method should provide a means for controlling overall healthcare costs while also ensuring adequate compensation to the medical practitioner in the program. Further, the method must engage the patient to follow doctors orders and to self-manage their health.

The general public normally views the patient and doctor as the health care system's primary components. However, many other elements contribute to the overall effectiveness and cost of health care delivery. The following discussion of the modern health care system will aid in understanding the advantages of the current invention.

Medical providers are the most visible component of the health care system. Providers include medical practitioners, e.g. doctors, hospitals pharmacies, medical laboratories, and other similar service providers. Equally critical to our system are the health care payors. Health care payors are those parties responsible for compensating the health care providers. Health care payors include insurance companies, HMO's, self-insured employers, Medicare, Medicaid, and patients without insurance. Another component of the health care system is the health care purchaser. Health care purchasers include patients without insurance or having insurance but responsible for a portion of health care cost, private employers and governments. Finally, there are those entities that assume the risk of paying for health care. These entities include the patient (co-pay, deductible or uninsured), the health insurance company, the self-insured employer, the government and medical groups such as HMO's.

The PPO is an organizational approach to controlling health care costs. PPO's provide health care purchasers with access to a group of medical providers. Additionally, the PPO negotiates provider fee schedules (allowables) and billing limits on services. Typically, the PPO will negotiate and establish the following: terms for filing and paying claims; credentials necessary to be a medical provider in the PPO; appeals processes; termination; and, other administrative activities. Further, the PPO provides necessary information to the health care purchaser such as directories of medical care providers, performance statistics and other data of interest to the medical care purchaser. The PPO may also re-price claims. However, except in instances where an insurance company owns the PPO, the PPO generally does not assume the risk of paying for the medical care.

HMOs differ from PPO's by more actively managing health care delivery. HMOs attempt to control health care costs by controlling the volume of services rendered. The most famous and controversial method used by HMOs to control costs is by pre-paying providers to care for a certain number of patients. These payments are referred to as capitations. This method shifts the financial risk for health coverage from an insurer to the provider. According to the pre-payment theory, providers earn more by managing the patient care. However, this also translates as restricted patient care, so the provider can either pocket the proceeds or prevent financial failure. HMOs and PPOs use other cost control or medical management techniques such as requiring pre-certification of surgical procedures and other special medical treatments. Some HMOs and PPOs incorporate a “gatekeeper,” such as a primary care physician, to control access to more expensive treatments and medical specialties. Other HMOs and PPOs attempt to control costs by active disease management or case management. These techniques focus on helping patients with conditions that tend to be expensive to treat. HMOs and PPOs tend to earn high marks when they promote preventive medicine as means for precluding the onset of a more serious and costly medical condition.

Insurance companies, a health care payor, provide insurance coverage against the costs of health care. They frequently use organizations such as PPO's and HMO's to manage costs and limit risk exposure. However, the insurance company may negotiate terms and fees directly with health care providers. A health care purchaser normally pays a “co-pay” and an annual deductible when treated by a health care provider under contract with an insurance company. The insurance company covers the remainder of the health care provider's fee paying the fee when the provider submits a claim for reimbursement. Frequently, the medical provider submits the claim to an HMO, PPO or the employer. These organizations re-price the claim according to the agreed upon rate schedule and provide payment to the health care provider. For the purposes of this disclosure the party or parties receiving the claim and directing the payment thereof is referred to as a payor. The payor may optionally re-price the claim on behalf of the party responsible for the actual costs of the medical services.

Finally, many self-insured employers purchase re-insurance. The re-insurance protects the employer against the cost of a catastrophic case and/or instances where the self-insured employer's total health care costs for the year exceed a given dollar amount.

Clearly, except for the efforts of the HMO, the current health care delivery system lacks a mechanism for controlling health care costs. The efforts of HMO's to control costs through managing care have increasingly come under attack from health care purchasers and providers. In particular, the methods of some HMO's appear to dictate health care practices without concern for the clinical outcome of the patient. Therefore, an improved system for controlling costs and improving the clinical outcome of the patient is needed for the health care delivery system.

### SUMMARY OF THE INVENTION

The current invention provides improved methods for delivering health care. The methods of the current invention are based on the premise that higher quality health care produces better clinical outcomes and lower overall costs. The methods of the current invention recognizes that the parties who have the greatest influence on better clinical outcomes, higher quality health care, and lower overall costs are the physician and their patient. Therefore, the method is designed to financially reward both the physician and the patient for voluntarily taking steps to improve the patient's health.

In one embodiment, the method comprises a medical practitioner treating a patient. Subsequently, the medical practitioner directs the patient to register with a medical information provider to obtain additional information concerning the treatment prescribed by the medical practitioner including information relating to prevention of future incidents of the problem and/or care and management of the medical problem. Upon registration with the medical information provider the patient receives the information. The medical information provider subsequently provides notice of the patient's registration to the patient's medical insurer and/or employer. As an incentive to the patient to register and review the available medical information, the insurer and/or employer refund at least a portion of the patient's costs relating to the treatment.

Additionally, the current invention is an improved method for providing medical treatment to a patient comprising the steps of medical practitioner treating a patient wherein the medical practitioner files a claim for compensation with a payor. The payor receives the claim for compensation and compares the prescribed treatment to a schedule of treatment guidelines. The payor pays the medical practitioner depending upon the medical practitioner's compliance with the treatment guidelines. Additionally, the medical practitioner prescribes or directs the patient to access an Internet website related to the prescribed treatment of the medical condition. When the patient registers at the prescribed website, a registration notice is preferably provided to the patient's medical insurer and/or employer. As an incentive for the patient to access the website, patient's medical insurer and/or employer refunds to the patient at least a portion of patient's costs relating to said treatment upon receiving notice of patient accessing the website.

The current invention is also an improved method for providing medical treatment to a patient comprising, the steps of treating a patient. The treating medical practitioner subsequently files a claim with a payor. Subsequently, the payor contacts the medical practitioner to determine compliance with an accepted schedule of evidence-based medicine treatment guidelines. Additionally, the payor provides the medical practitioner with a means for accessing educational material relating to the prescribed treatment. If the medical practitioner confirms that the prescribed treatment is within the accepted schedule of treatment guidelines, the payor will compensate the medical practitioner at a higher rate than compared to a prescribed treatment outside of the guidelines. Following receipt of the means to access the educational material, the medical practitioner will provide this means to the patient. Thereafter, the patient preferably accesses the educational material. The payor confirms patient review of the educational material and contacts the patient's employer and/or patient's medical insurer. Preferably, the employer and/or medical insurer refund to the patient at least a portion of patient's costs relating to the treatment as an incentive to the patient to review the educational material.

Further, the current invention relates to a method of providing medical treatment to a patient comprising the steps of treating a patient, then directing the patient to review educational literature related to the prescribed treatment. Preferably, the patient receives a password granting access to a website containing the educational literature. Following confirmation of the patient's review of the educational literature, at least a portion of the costs incurred by the patient to the patient will be refunded to the patient.

Another embodiment of the current invention relates to a method for providing medical treatment to the patient and compensating the medical practitioner comprising the steps of treating a patient and directing the patient to review educational literature relating to the prescribed treatment. Preferably, the patient receives a password granting access to a website containing the educational literature. Optionally, following confirmation of patient's review of the educational literature, at least a portion of the costs incurred by the patient to the patient will be refunded to the patient. Additionally, the method compares the prescribed treatment to an approved schedule of treatments for the patient's medical condition and optionally compensates the medical practitioner based on conformity of the prescribed treatment with the approved schedule of treatments for the medical condition.

Still further, the current invention relates to a method for providing medical treatment to a patient and compensation to a medical practitioner comprising the steps of treating a patient and directing the patient to review educational literature. Following confirmation of patient's review of the educational literature, the method directs the refund of at least a portion of the costs incurred by the patient. Additionally, the method compares the prescribed treatment to an approved schedule of treatments for the patient's medical condition. Optionally, the method determines the medical practitioner's rate of compensation on the basis of conformity of the prescribed treatment with the approved schedule of treatments for the medical condition.

In yet another embodiment, the current invention relates to a method for providing medical treatment to a patient and compensation to a medical practitioner comprising the steps of treating a patient and providing the patient with access to a website containing educational literature relating to the prescribed treatment. Following confirmation of patient's review of the educational literature, the method directs at least a portion of the costs incurred by the patient to be refunded to the patient. Additionally, the method compares the prescribed treatment to an approved schedule of treatments for the patient's medical condition and determines the rate at which to compensate the medical practitioner on the basis of conformity with the approved schedule of treatments.

Finally, the method of the current invention begins with a medical practitioner rendering health care to a patient. Subsequently, the medical practitioner files a claim for compensation with the payor. The payor and/or its designated claims re-pricing service receives the claim for compensation and compares the primary medical diagnosis on the practitioner's claim to a schedule of medical diagnoses related to a set of treatment guidelines. The payor notifies the medical practitioner via an email or other electronic means when the primary medical diagnosis corresponds to a diagnosis on the schedule of medical diagnoses. Preferably, the schedule of medical diagnoses is contained in an evidence-based medicine guideline database. The notice will allow the medical practitioner access to a secure Internet website. When the medical practitioner accesses the secure website; the patient's name, date of service, primary diagnosis and related medical services from the medical practitioner's claim will be revealed. The medical practitioner is informed that he/she will receive a higher rate of reimbursement if the method of treating the medical condition corresponds to a treatment guideline on the schedule of medical diagnoses. The website gives the medical practitioner the opportunity to review the medical treatment guideline and to indicate adherence with the guideline. If the medical practitioner responds in the affirmative, then the payor will automatically have its clients (health insurers and self-insured employers) reimbursement the medical practitioner at a higher rate of compensation.

The website will also allow the medical practitioner to prescribe or direct the patient to access the Internet website to access information to help the patient manage his or her own care. When the patient registers on the website and completes a questionnaire, then the can notify the patient's medical insurer and/or employer of the patient's effort to help manage their own health care. As an incentive and a reward, the patient's medical insurer and/or employer can choose to refund/rebate to the patient a portion of the patient's costs (deductible, co-pay, and/or payroll deducted share of health coverage).

### DETAILED DISCLOSURE OF THE PREFERRED EMBODIMENTS OF THE CURRENT INVENTION

The current invention relates to improved methods for delivering health care. The improved method provides a financial incentive to practice quality medical treatment and healthy living to those in the best position to control health care costs.

To determine the best manner of providing health care, consider the following mathematical formula:

TOTAL COST=(PRICE/UNIT)(UNITS OF TREATMENT)(PATIENT COMPLIANCE)

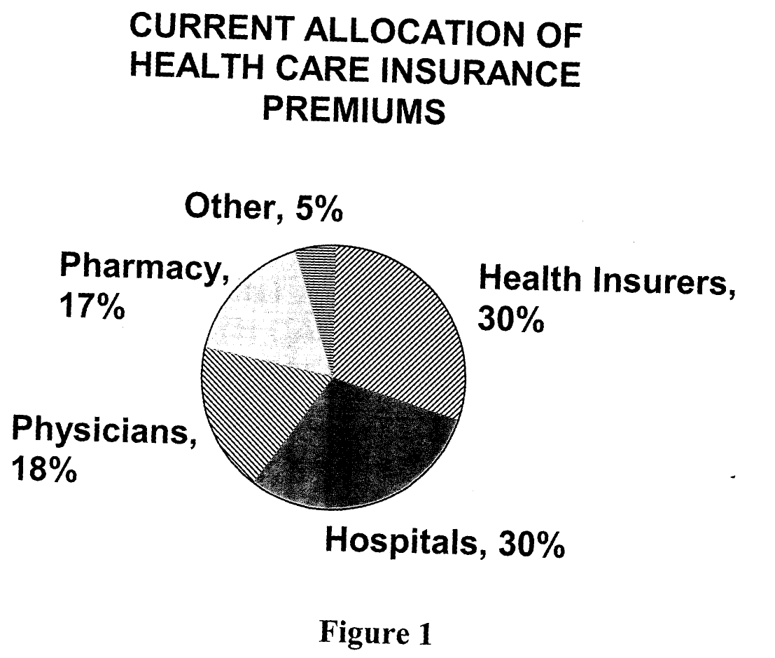

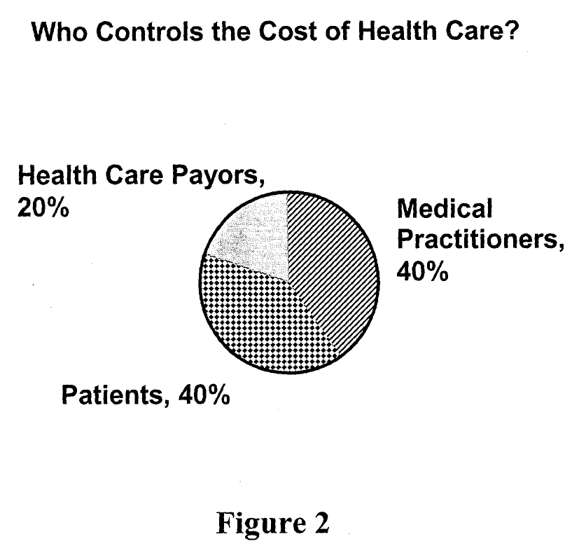

This formula demonstrates that medical providers and patients exert the greatest influence on total health care costs. However, these two groups are not primarily responsible for payment of health care costs. Rather, the primary health care payors and delivers of health care are insurance companies, PPOs, HMOs, self-insured employers, Medicare, Medicaid, and patients without insurance. As a result, a dichotomy exists between the efforts to deliver quality health care and the effort to control health care costs. FIGS. 1 and 2, Allocation of Insurance Premium and Control of Health Care Costs, graphically represent this dichotomy. Providing quality health care at an affordable cost will require a system designed to overcome this dichotomy. Preferably, the system will provide suitable incentives to both the patient and the medical provider to bring about a change in behaviors resulting in better clinical outcomes for the patient and lower overall costs for the heath care system. For the purposes of the remainder of this discussion, the current invention focus on services delivered by a medical practitioner such as a physician; however, the methods of the current invention apply equally well to all medical providers.

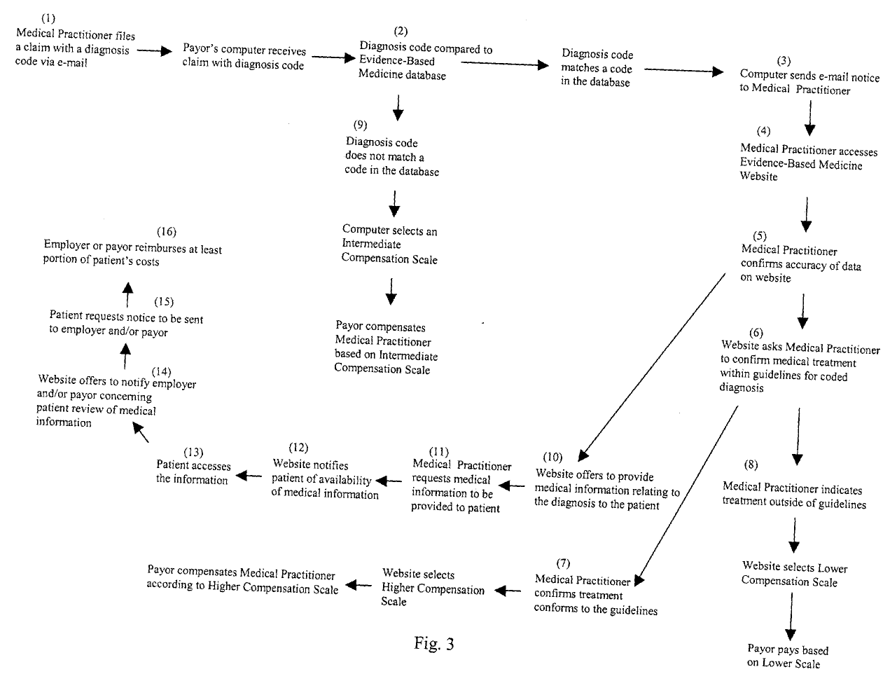

The current invention provides such incentives by application of evidence-based medicine and preferably the Internet. The methods of the current invention improves patient clinical outcome and enhances the financial outcome for both the patient and the medical practitioner. The health care delivery methods of the current invention will be described with reference to the flow chart in FIG. 3. To aid in identification of the various steps of the current invention identifying numbers are provided for selected portions of the process. Electronic communications, such as but not limited to the Internet and email, provide the most efficient means for practicing the methods of the current invention. However, the methods of the current invention may be readily adapted to traditional mail and other hard copy communications or a blend of electronic communication and traditional communications.

As shown in FIG. 3, the method of the current invention begins (1) when a medical practitioner files a claim for reimbursement with a health care payor. Typically, the payor is a claims clearinghouse or other claims re-pricing entity. Preferably, the practitioner files the claim electronically. The medical claim contains information commonly found on current claim forms such as the patient's name, the practitioner's name, a primary medical diagnosis and the service provided by the practitioner.

Upon receipt of the claim, the medical diagnosis is compared (2) to a list of medical diagnoses contained in the evidence-based medicine guideline database. If the database contains the diagnosis, then the practitioner receives a notification informing the practitioner to access the evidence-based medicine guideline database (3). In the preferred embodiment, the current invention provides the means for automatically comparing the medical diagnosis to the database and automatically transmitting a notice to the practitioner. For example, a practitioner will preferably file the claim electronically with the diagnosis identified by a predetermined code. A computer capable of comparing the diagnosis code to the evidence-based medicine guideline database receives the claim. If the encoded diagnosis matches the code for medical diagnosis within the evidence-based medicine guideline database, then the computer automatically transmits an email or generates a regular letter for mailing to the practitioner. The notification advises the practitioner to access the website that contains the evidence-based medicine guidelines. The website is preferably a secure website requiring input of an access code prior to gaining access to the data contained therein. The notification may contain the necessary access code and may also contain a patient identifier code. Alternatively, these codes may be transmitted by a separate email or otherwise provided to the practitioner.

Upon entry of the appropriate codes or passwords at the website (4), the website identifies the name of the patient, the date of service, the medical diagnosis and related medical services. The website also provides the evidence based medical guidelines corresponding to the diagnosis. Preferably, the practitioner reviews and confirms the accuracy of the information found on the website (5).

The evidence-based medicine website is an interactive website. As such, it queries the practitioner concerning adherence to evidence-based medicine guidelines for the diagnosis (6). The practitioner's response to the query will determine the rate schedule used to compensate the practitioner for services rendered. If the practitioner confirms treatment within the scope of the evidence-based medicine guidelines (7), then the website will direct compensation to be made according to a higher payment rate scale. Typically, the medical practitioner must access the interactive website the within 48 to 72 hours of receipt of the notification in order to qualify for the higher payment rate scale. If the medical practitioner indicates that treatment was not within specified guidelines or does not respond within the indicated period of time (8), then the website will direct compensation to be made according to a lower rate scale.

Preferably, the medical practitioner accesses the website from time to time to obtain the current evidence-based medicine guidelines. Thus, the website provides an additional reference source for the medical practitioner.

In instances where the medical practitioner's diagnosis does not correspond to a diagnosis contained in the evidence-based medicine database (9), then a notification to contact the website will not be sent to the medical practitioner. Under these conditions, the payor will direct its clients (health insurers and self-insured employers) to compensate the medical practitioner at an intermediate rate. Preferably, the medical practitioner will continue to file claims for compensation via email or other electronic means even when a code does not exist for diagnosis. As noted above, an electronically filed claim is “read” by a computer. When the computer does not find a code corresponding to a medical diagnosis in the evidence-based medicine database, the computer will automatically direct compensation to be paid according to an intermediate rate scale.

The foregoing steps of the method of the current invention provide an incentive to the, medical practitioner to comply with the treatments specified in the evidence-based medicine guideline database. The treatments specified in the evidence-based medicine database are the preferred treatments as determined by leading medical schools in the United States. In particular, the following schools conduct rigorous reviews of medical conditions and provide guidelines for treatments generally accepted by medical practitioners as the preferred treatments for the identified medical conditions. Schools currently developing preferred treatment guidelines include: Duke, Vanderbilt, Emory, Mount Sinai NYU Health, Washington University in St. Louis, and Oregon Health Science University.

Providing an incentive to the medical practitioner addresses only one part of the mathematical formula discussed above. In order to further improve the patient's clinical outcome and enhance health care cost control, the patient must also play a role. Accordingly, the methods of the current invention provide an incentive to the patient to take a pro-active approach to recovery from and prevention of medical conditions.

With continued reference to FIG. 3, the method of the current invention provides the patient with medical information relating to the diagnosed medical condition. The method preferably relies upon the medical practitioner to decide if the patient should receive the proposed medical information. Preferably, the practitioner will be given the option of making such information available to the patient at the same time the practitioner is interacting with the website concerning compliance of the medical treatment with the evidence-based medicine guidelines. Typically, a medical information provider will offer the practitioner the opportunity to provide the patient medical information relating to the diagnosis (10). Preferably, the medical practitioner accesses the medical information provided by the website. For the remainder of this discussion, the medical information provider will be referred to as the website. If the practitioner accepts the website's offer to provide medical information to the patient (11), then an email or regular letter will be sent automatically to the patient. This patient notification (12) may contain the medical information or it may contain a password granting the patient access to the website. Preferably, the notification provides a mechanism for notifying the payor of patient's review of the relevant medical information. Thus, the preferred notification is an electronic notice such as an email containing a password.

Upon receipt of the correspondence, the patient is expected to review the medical information made available. Additionally, the patient is provided with a means for notifying their employer and/or health care payor of the receipt and review of the medical information. Preferably, the patient views the medical information on-line (13) and completes an on-line questionnaire concerning their medical condition. Following completion of the on-line questionnaire, the website provides the patient with the option of electronically notifying the employer and/or payor of patient's review of the medical information (14). Due to the incentives offered by the method of the current invention, the patient will likely request a notice to be sent to the employer and/or payor (15). Upon receipt of such notice, either the payor or the employer has the option of refunding at least a portion of the patient's out of pocket expenses for the medical treatment (16). In accordance with the Health Insurance Portability and Accountability Act, the notice does not divulge any protected patient health information.

Clearly, this portion of the current invention provides an incentive to the patient to take an active role in managing their medical condition. As a result, the clinical outcome of the patient's medical treatment will be enhanced. Thus, the methods of the current invention enhance the quality of medical care by ensuring treatment of medical conditions in accordance with the most widely preferred treatment guidelines and by enabling the patient to manage the treatment of the medical condition. By enhancing the quality of medical care and increasing the patient's ability to manage their medical condition, the current invention reduces the overall costs of health care while providing an increase in compensation to the medical practitioner.

As indicated above, the methods of the current invention are preferably carried out by means of electronic communication such as the Internet and electronic mail. However, the methods of the current invention may also be practiced via regular mail and provision of hard copy medical information. The use of electronic communications will in general improve the efficiency of the current invention. Further, those skilled in the art will recognize the ability to combine traditional paper communications and electronic communications during the practice of the current invention. Other embodiments of the current invention will be apparent to those skilled in the art from a consideration of this specification or practice of the invention disclosed herein. However, the foregoing specification is considered merely exemplary of the current invention with the true scope and spirit of the invention being indicated by the following claims.

We claim:

1. A method for providing medical treatment to a patient comprising the steps of:
a medical practitioner treating a patient and directing the patient to register with a medical information provider;
the patient registering with the medical information provider;
said medical information provider providing notice of patient registration to patient's medical insurer and/or employer; and,
patient's medical insurer and/or employer refunding to the patient at least a portion of patient's costs relating to said treatment.

2. The method of claim 1, further comprising the steps of:
the medical practitioner filing a claim with a payor;
the payor comparing medical practitioners treatment to a schedule of treatment guidelines;
payor compensating or directing the compensation of the medical practitioner.

3. The method of claim 2, wherein the medical practitioner receives a higher rate of compensation if the medical practitioner's treatment corresponds to the schedule of treatment guidelines.

4. The method of claim 2, wherein the medical practitioner utilizes electronic means to file the claim with the payor.

5. The method of claim 1, wherein the medical practitioner provides the patient with a password to a website supported by the medical information provider

6. The method of claim 5, wherein use of the password by the patient automatically registers the patient with the medical information provider.

7. The method of claim 6, wherein use of the password by the patient automatically notifies patient's medical insurer and/or employer.

8. The method of claim 5, wherein said payor provides said password to said medical practitioner.

9. The method of claim 5, further comprising the steps of said patient using said password and completing an online questionnaire and wherein in response to said patient completing said online questionnaire said website automatically submits notice of patient registration with said website to patient's medical insurer and/or employer.

10. The method of claim 8, wherein the payor utilizes electronic means to confirm medical practitioner compliance with the schedule of treatment guidelines

11. A method for providing medical treatment to a patient comprising the steps of:
a medical practitioner treating a patient;
the medical practitioner filing a claim for compensation with a payor;
the payor comparing the treatment with a schedule of treatment guidelines;
the medical practitioner prescribing Internet access for the patient to a website related to the medical practitioner's treatment of patient's condition;
the patient registering at the prescribed website;
notice of patient registration provided to patient's medical insurer and/or employer; and,
patient's medical insurer and/or employer refunds to the patient at least a portion of patient's costs relating to said treatment.

12. The method of claim 11, wherein the medical practitioner receives a higher rate of compensation from the payor if the medical practitioner's treatment corresponds to the schedule of treatment guidelines.

13. The method of claim 11, wherein the medical practitioner provides the patient with a password to the prescribed website.

14. The method of claim 13, wherein said payor provides said password to said medical practitioner.

15. The method of claim 13, wherein the patient's use of said password automatically registers the patient with the payor.

16. The method of claim 15, wherein use of said password by said patient automatically submits notice of patient registration with said website to patient's medical insurer and/or employer.

17. The method of claim 15, wherein patient use of said password and review of at least a portion of said educational material automatically submits notice of patient registration with said website to patient's medical insurer and/or employer.

18. The method of claim 11, wherein the medical practitioner utilizes electronic means to file the claim with the payor.

19. The method of claim 11, wherein the payor utilizes electronic means to confirm medical practitioner compliance with the schedule of treatment guidelines

20. The method of claim 19, further comprising the step of electronically transmitting a password granting access to the website related to the treatment of patient's condition to the medical practitioner.

21. The method of claim 16, wherein the patient obtains medical information relating to the treatment after entering the password at the website.

22. A method for providing medical treatment to a patient comprising the steps of:
a medical practitioner treating a patient;
said medical practitioner filing a claim with a payor;
said payor contacting the medical practitioner to determine compliance with a schedule of treatment guidelines;
providing a means for accessing educational material relating to the treatment to said medical practitioner;
said medical practitioner confirming treatment within treatment guidelines;
said medical practitioner providing the means for accessing the educational material to the patient;
said payor providing compensation to medical practitioner;
said patient accessing the educational material concerning the treatment;
said payor confirming patient review of information
said payor contacting patient's employer and/or patient's medical insurer; and,
said patient's employer and/or patient's medical insurer refunding to the patient at least a portion of patient's costs relating to said treatment.

23. The method of claim 22, wherein the medical practitioner receives a higher rate of compensation from the payor if the medical practitioner's treatment corresponds to the schedule of treatment guidelines.

24. The method of claim 22, wherein the medical practitioner utilizes electronic means to file the claim with the payor.

25. The method of claim 24, further comprising the step of said payor providing said means for accessing the educational material in the form of a password to a website containing said educational material in response to the electronic filing of the claim by said medical practitioner.

26. The method of claim 23, wherein the patient's use of said password automatically registers the patient with the payor.

27. The method of claim 26, wherein use of said password by said patient automatically submits notice of patient registration with said website to patient's medical insurer and/or employer.

28. The method of claim 26, wherein patient use of said password and review of at least a portion of said educational material automatically submits notice of patient registration with said website to patient's medical insurer and/or employer.

29. The method of claim 22, wherein the payor utilizes electronic means to confirm medical practitioner compliance with the schedule of treatment guidelines.

30. The method of claim 29, further comprising the step of electronically transmitting a password as the means for accessing the educational material on a website related to the treatment of patient's condition to the medical practitioner.

31. The method of claim 27, wherein the patient obtains medical information relating to the treatment after entering the password at the website.

32. A method for providing medical treatment to a patient comprising the steps of:
treating a patient;
directing the patient to review educational literature relating to the treatment;
confirming patient review of the educational literature; and,
refunding at least a portion of the costs incurred by the patient to the patient.

33. The method of claim 32, further comprising the steps of:
comparing the treatment with an approved schedule of treatments of medical conditions; and,
compensating the medical practitioner according to a tiered rate of reimbursement, said reimbursement being greater when the medical practitioner treats the patient in accordance with an approved guideline.

34. The method of claim 32, wherein the approved schedule of treatments is a schedule of evidence-based medicine guidelines for treatment of medical conditions.

35. The method of claim 32, further comprising the step of providing a password to the patient, said password being associated with a website containing educational literature relating to the treatment.

36. The method of claim 34, wherein the step of confirming patient review of the educational literature is carried out over the Internet.

37. The method of claim 35, wherein use of the password automatically confirms patient access of the educational literature.

38. The method of claim 35, wherein use of the password and completion of an online survey automatically confirms patient access of the educational literature.

39. The method of claim 33, further comprising the steps of filing a claim for compensation with a payor, the step of filing the claim being carried out over the Internet.

40. The method of claim 33, wherein the level of compensation is greater when the treatment conforms to the approved schedule of treatments.

41. A method for providing medical treatment to a patient and compensation to a medical practitioner comprising the steps of:
treating a patient;
directing the patient to review educational literature relating to the treatment;
comparing the treatment to an approved schedule of treatments of medical conditions; and,
confirming patient review of the educational literature.

42. The method of claim 41, wherein the approved schedule for treatment of medical conditions is a schedule of evidence-based medicine guidelines for treatment of medical conditions.

43. The method of claim 41, further comprising the steps of:
compensating the medical practitioner; and,
refunding at least a portion of the costs incurred by the patient to the patient.

44. The method of claim 42, wherein the compensation provided to the medical practitioner is greater when the treatment conforms to the approved schedule of treatments.

45. The method of claim 41, further comprising the step of providing a password to the patient, said password being associated with a website containing educational literature relating to the treatment.

46. The method of claim 41, wherein the step of confirming patient review of the educational literature is carried out over the Internet.

47. The method of claim 44, wherein use of the password automatically confirms patient access of the educational literature.

48. The method of claim 45, wherein use of the password and completion of an online survey automatically confirms patient access of the educational literature.

49. The method of claim 41, further comprising the steps of filing a claim for compensation with a payor, the step of filing the claim being carried out over the Internet.

50. The method of claim 41, wherein the step of comparing the treatment to the approved schedule of treatments is carried out over the Internet.

51. A method for providing medical treatment to a patient and compensation to a medical practitioner comprising the steps of:
treating a patient;
directing the patient to review educational literature relating to the treatment;
comparing the treatment with an approved database of evidence-based medicine guidelines;
confirming patient review of the educational literature;
compensating the medical practitioner;
refunding at least a portion of the costs incurred by the patient to the patient.

52. The method of claim 51, further comprising the step of compensating the medical practitioner at a higher rate when the practitioner treats the patient in accordance with an approved evidence-based medicine guideline.

53. A method for providing medical treatment to a patient and compensation to a medical practitioner comprising the steps of:
treating a patient;
providing the patient with access to a website containing educational literature relating to the treatment;
comparing the treatment to an approved schedule of evidence-based medicine guidelines;
confirming patient review of the educational literature;
compensating the medical practitioner according to a rate schedule determined by compliance with the approved schedule of evidence-based medicine guidelines; and,
refunding at least a portion of the costs incurred by the patient to the patient.

54. The method of claim 53, wherein use of the password automatically confirms patient access of the educational literature.

55. The method of claim 53, wherein use of the password and completion of an online survey automatically confirms patient access of the educational literature.

56. The method of claim 53, further comprising the steps of filing a claim for compensation with a payor, the step of filing the claim being carried out over the Internet.

57. The method of claim 53, wherein the step of comparing the treatment to the approved schedule of treatments is carried out over the Internet.

58. A method for improving health care clinical and financial outcomes comprising the steps of:
submitting a claim for compensation, said claim containing a medical diagnosis;
comparing the medical diagnosis in the claim to a list of medical diagnoses;
notifying the medical service provider if the medical diagnosis matches a medical diagnosis on said list;
referring the medical service provider to a website, the website providing the name of the patient, date of service, the patient's medical diagnosis and the related medical services, and the evidence-base medicine guideline related to the medical diagnosis and medical information related to the diagnosis;
the medical service provider reviewing and confirming adherence to the evidence-based medicine guideline;
the website selecting a higher compensation rate scale when the medical service provider confirms compliance with the evidence-based medicine guideline;
the website contacting the patient and providing the patient with instructions for accessing the medical information relating to the diagnosis;
the website providing the patient with the means for notifying the patient's employer and/or health care payor with notice of patient's review of the medical information;
rebating at least a portion of patient's costs relating to the medical condition.

59. The method of claim 58, wherein the steps of submitting the claim for compensation and notifying the medical service provider are carried out by email.

60. The method of claim 58, wherein the website is a secure password protected website.

61. The method of claim 58, wherein the medical service provider must review and confirm adherence to the evidence-based medicine guideline within 48 to 72 hours.

62. The method of claim 61, wherein failure to review and confirm adherence within 72 hours results in compensation based on a lower rate scale.

63. The method of claim 58, wherein a diagnosis not found within the list of medical diagnosis is compensated based on an intermediate rate scale.

64. The method of claim 58, further comprising the step of the medical service provider requesting the website to contact the patient.

65. The method of claim 64, wherein the website contacts the patient by means of email.

66. The method of claim 65, wherein the email transmitted from the website to the patient contains a password granting access to the website.

67. The method of claim 58, further comprising the step of offering to notify the patient's employer and/or payor following patient's accessing the website.

68. The method of claim 67, further comprising the step of notifying the patient's employer and/or payor by means of an email following a request submitted by said patient.
